(19) United States
(12) Patent Application Publication
(10) Pub. No.: US 2006/0098839 A1
(43) Pub. Date: May 11, 2006

(54) Voice coil device and manufacturing method thereof

(75) Inventors: Toshihiro Ishigaki, Yamagata (JP); Seiya Sato, Yamagata (JP)

Correspondence Address: ARENT FOX PLLC, 1050 CONNECTICUT AVENUE, N.W., SUITE 400, WASHINGTON, DC, 20036, US

(73) Assignee: PIONEER CORPORATION and TOHOKU PIONEER CORPORATION

(21) Appl. No.: 11/264,148

(22) Filed: Nov. 2, 2005

(30) Foreign Application Priority Data
Nov. 5, 2004 (JP) 2004-322445

(51) Int. Cl. H04R 9/06

(52) U.S. Cl. 381/400; 381/409; 381/410

(57) ABSTRACT

A voice coil device is provided, which includes a bobbin made by rounding a thin plate of a high-strength metal material into a tubular shape, a heat-resistant fiber/resin composite film attached to a surface of the bobbin such as to cover at least abutting ends of the thin plate, and a wire for the voice coil wound around on the heat-resistant fiber/resin composite film. The voice coil device with reduced weight is suitable for a high-input speaker, and has high heat resistance and high strength.

### BACKGROUND OF THE INVENTION

The present invention relates to a voice coil device and a manufacturing method thereof.

The present application claims priority from Japanese Patent Application No. 2004-322445, the disclosure of which is incorporated herein by reference.

A voice coil device is a component of a speaker system and formed by winding voice coil wires coated with an insulating material around a bobbin, which is either a film-like member rounded into an annular shape or a tubular molded piece. The voice coil device transmits vibration of the voice coil generated by an input signal to a diaphragm. Generally, the voice coil device should be as light as possible to achieve a high sound pressure level for good sound reproduction, and should have high strength to achieve sufficient durability to withstand bending distortion that occurs due to vibration.

Moreover, a voice coil device used in a high-input speaker such as a subwoofer speaker system with input power of more than 5000 W is required to have heat resistance to withstand heat generated in the voice coil. The bending strength of the bobbin is also essential to achieve durability, because the above-noted bending distortion is larger at high input levels.

Conventional techniques in designing a voice coil device suitable for high-input speakers include superposing a plurality of heat resistant film materials such as glass imide film or polyimide film and rounding these films to form a bobbin, and using a bobbin formed of a woven cloth of heat-resistant fiber (obtained by introducing an imide ring to heterocyclic polyimide) and a binder resin consisting of silicon resin (see Japanese Patent Un-examined Publication No. Hei 7-75197).

Meanwhile, with the development of wires with improved heat resistance such as ceramic-coated wires (as disclosed in Japanese Patent Un-examined Publication No. 2002-222616), the speaker input power level has drastically increased, which has led to a new problem of cracks in bobbins, because the bobbins made of the above-noted fiber or resin are not sufficiently durable.

A possible solution would be to use a bobbin made of a high-strength metal material such as titanium, but that will raise the following problems:

First, a high-strength metal material such as titanium does not easily allow itself to be formed into a tubular shape because of its high rigidity. Bobbins made by rounding a plate-like member of such a material cannot have high roundness because it is hard to round the abutting ends. Moreover, burrs can readily be formed at ends during the forming process, and wires wound around such a bobbin with low roundness and burrs can easily be damaged, because of which disconnection or short-circuiting may occur.

Second, the use of the high-strength metal material such as titanium will increase the weight of the voice coil device because of high specific gravity of the material, which is not preferable if the speaker's sound pressure level is to be increased. On the other hand, if the bobbin is made thinner to reduce weight, it will not be strong enough to withstand bending distortion that occurs due to vibration.

Third, wires wound around a bobbin made of a high-strength metal material such as titanium will easily slip off at high input levels because of the smooth and hard surface of the bobbin. Moreover, because of high heat conductivity, a metal bobbin will conduct heat from the voice coil to the joints between the bobbin and a diaphragm or with a damper. This causes thermal damage to these joints, because of which the voice coil device may be detached.

### SUMMARY OF THE INVENTION

An object of the present invention is to solve these problems in the conventional technique. More specifically, the invention aims at providing a voice coil device having sufficient strength to achieve high-input durability; forming the bobbin with high roundness using a high-strength metal material such as titanium; preventing damage to the voice coil wires; reducing the weight of the bobbin to achieve a high sound pressure level while maintaining sufficient durability; preventing the problem of wire slippage from the bobbin; and preventing the problem of voice coil device detachment.

To achieve the above objects, the present invention provides a voice coil device and its manufacturing method having the following characteristic features:

A voice coil device for transmitting vibration of a voice coil generated by an input signal to a speaker diaphragm, including a bobbin made by rounding a thin plate of a high-strength metal material into a tubular shape, a heat-resistant fiber/resin composite film attached to a surface of the bobbin such as to cover at least abutting ends of the thin plate, and a wire for the voice coil wound around on the heat-resistant fiber/resin composite film.

A method of manufacturing a voice coil device for transmitting vibration of a voice coil generated by an input signal to a speaker diaphragm, the method including the steps of forming a bobbin by rounding a thin plate of a high-strength metal material into a tubular shape, attaching a heat-resistant fiber/resin composite film to a surface of the bobbin such as to cover at least abutting ends of the thin plate, and winding wires around on the heat-resistant fiber/resin composite film.

### BRIEF DESCRIPTION OF THE DRAWINGS

These and other objects and advantages of the present invention will become clear from the following description with reference to the accompanying drawings, wherein:

FIG. 1 is a cross-sectional view showing a voice coil device according to one embodiment of the present invention;

FIG. 2A and FIG. 2B are diagrams illustrating examples of how the heat-resistant fiber/resin composite film can be attached in the embodiment;

FIG. 3A and FIG. 3B are diagrams illustrating examples of how the heat-resistant fiber/resin composite film can be attached in the embodiment;

FIG. 4A and FIG. 4B are diagrams for explaining the effect achieved by the voice coil device according to the embodiment of the invention; and

FIG. 5 is a diagram illustrating a working example of the invention.

### DETAILED DESCRIPTION OF THE PREFERRED EMBODIMENTS

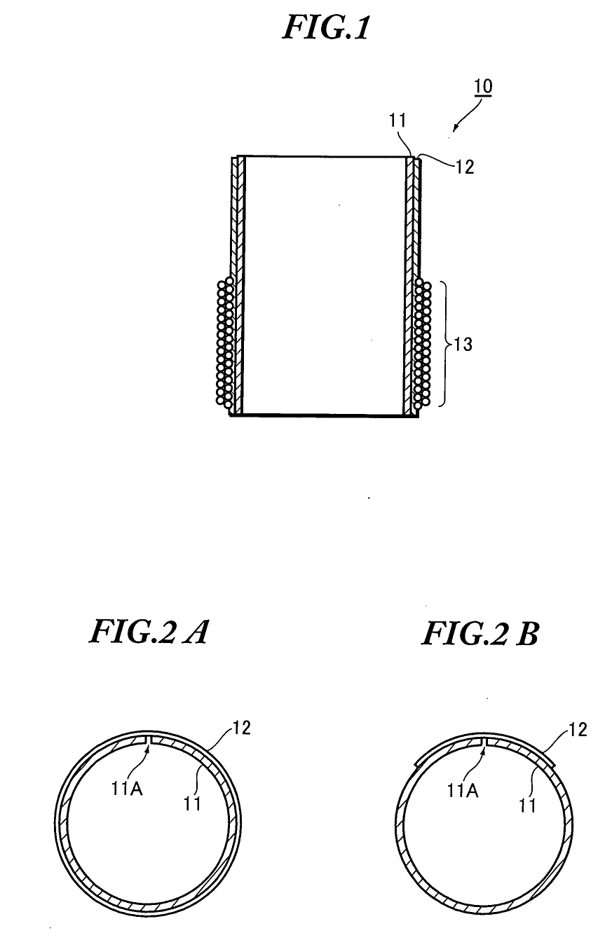

Preferred embodiments of the present invention will be hereinafter described with reference to the drawings. FIG. 1 is a cross-sectional view illustrating one embodiment of the voice coil device of the invention. The voice coil device 10 includes a bobbin 11, a heat-resistant fiber/resin composite film 12, and a voice coil 13. The voice coil device 10 transmits vibration of the voice coil 13 generated by an input signal to a speaker diaphragm.

The bobbin 11 is formed by rounding a thin plate of a high-strength metal material into a tubular shape. The high-strength metal material may be, but not limited to, titanium, or titanium-based alloys.

The heat-resistant fiber/resin composite film 12 is attached to the surface of the bobbin 11 such as to cover at least the abutting ends 11A of the thin plate as shown in FIG. 2A or FIG. 2B. That is, the film 12 may be attached to the entire circumference of the bobbin 11 as shown in FIG. 2A, or, attached to part of the bobbin 11 such as to cover the abutting ends 11A as shown in FIG. 2B.

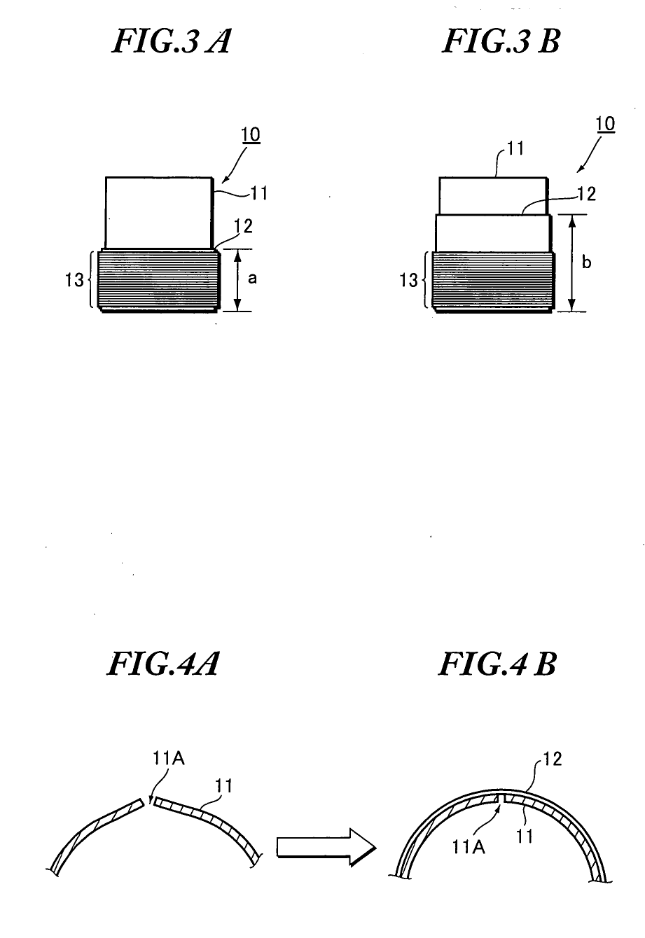

Moreover, the heat-resistant fiber/resin composite film 12 may be attached to the bobbin 11 such as to extend over the entire height of the bobbin as shown in FIG. 1, or, attached to the bobbin such as to cover only the area where the voice coil wires are wound around as indicated by arrow a in FIG. 3A. Alternatively, the film 12 may be attached to the bobbin 11 such as to cover the area from the bottom end of the voice coil 13 to a midpoint of the bobbin 11 as indicated by arrow b in FIG. 3B.

The heat-resistant fiber/resin composite film 12 is a resin-coated cloth material made of heat-resistant fiber. Examples of heat-resistant fibers for the cloth material include, but not limited to, organic fibers such as aramid fibers, liquid crystal polymer fibers, acetate fibers, polyamide fibers and the like; and inorganic fibers such as glass fibers, ceramic fibers, silicon carbide fibers, boron fibers, amorphous fibers and the like. Examples of coating resin materials include, but not limited to, polyimide resin, polyamide resin, phenolic resin, AS resin, ABS resin, PP resin, polyester resin, polyurethane resin, vinyl chloride resin, polystyrene resin, polycarbonate resin, polyphenylene ether resin, polyphenylene sulfide resin, acrylic resin, polyether resin, and the like. The minimum requirements for the physical properties of the film material are heat resistance, some degree of elasticity, and a necessary level of tensile strength.

The voice coil 13 is a commonly used type and consists of a coil of wires coated with insulating material. Ceramic coated wires may be used as mentioned above for a high-input speaker system.

A manufacturing method of this voice coil device is described next. First, a thin plate made of the high-strength metal material mentioned above is rounded into a tubular shape to form the bobbin 11. (The bobbin 11 need not remain tubular on its own at this stage; it only needs to be maintained tubular by attaching the heat-resistant fiber/resin composite film 12.) Next, the film 12 is attached to the surface of the bobbin 11 such as to cover at least the abutting ends of the thin plate. The film 12 may be prepared in an annular shape in advance so that the rounded bobbin 11 can be inserted thereinto, or, the film may be bonded from outside to the rounded bobbin 11. After that, the wires of the voice coil 13 are wound around on the film 12, to complete the above-described voice coil device 10.

The effects achieved by the voice coil device 10 and its manufacturing method having the above-described characteristic features are as follows:

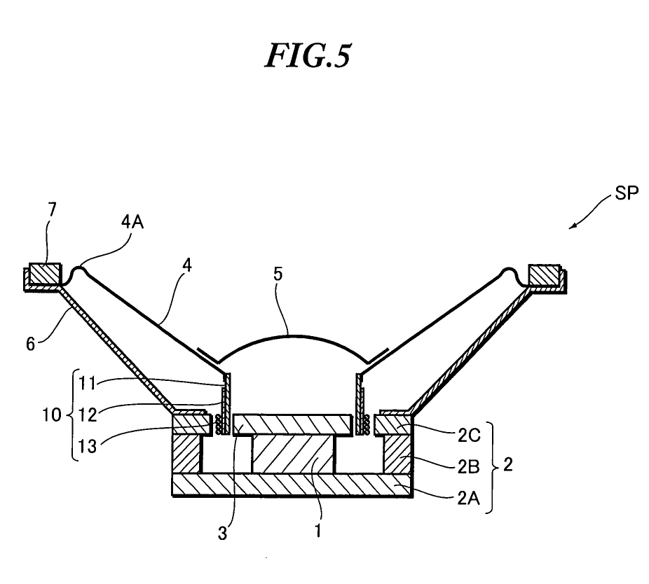

If the thin plate of high-strength metal material alone is to be formed into the bobbin 11, the abutting ends 11A of the bobbin 11 can hardly be rounded because of the high rigidity of the metal material. The ends of the thin plate tend to extend outwards as shown in FIG. 4A and high roundness of the bobbin 11 is hard to achieve. This will lead to the problem of damage to the voice coil wires, and the low roundness may lead to the problem of a bond or support failure in the structure of attaching the voice coil device to the speaker diaphragm or the like, as described in the foregoing. With this embodiment of the invention, however, because the heat-resistant fiber/resin composite film 12 is attached to the surface of the bobbin 11 such as to cover at least the abutting ends 11A, the film presses down the ends of the thin plate of the high-strength metal material that tend to stretch open, whereby the bobbin 11 can be formed with high roundness.

With the improved roundness of the bobbin 11, the voice coil device 10 according to the embodiment of the present invention offers the following advantages: The voice coil wires are less likely to be damaged, and disconnection or short-circuiting of the voice coil 13 will hardly occur. The bobbin 11 can be mounted to the speaker diaphragm or the like easily and securely, and the vibration behavior of the bobbin 11 will be made stable. Moreover, in the manufacturing process of the voice coil device 10, the voice coil wires can be wound around with high accuracy and with ease due to the high roundness of the bobbin 11.

To achieve the high roundness of the bobbin 11, the embodiment shown in FIG. 1 is most effective, wherein the heat-resistant fiber/resin composite film 12 is attached over the entire circumference and height of the bobbin 11, but other embodiments can also provide similar effects. That is, the film 12 may be attached to part of the bobbin 11 to cover the abutting ends 11A as shown in FIG. 2B, or, the film 12 may be attached to cover the area where the voice coil wires are wound around or the area from the bottom end of the voice coil to a midpoint of the bobbin 11, as shown in FIG. 3A or FIG. 3B.

While high-strength metal materials such as titanium generally have a high specific gravity, the bobbin 11 of this voice coil device 10 according to the embodiment of the invention can be made thinner because of the heat-resistant fiber/resin composite film 12, which ensures the strength of the thin plate of high-strength metal material. Therefore, the voice coil device 10 can be made lighter while maintaining a necessary bending strength, whereby the sound pressure level of the speaker can be increased. Furthermore, while high-strength metal materials such as titanium have high hardness and hard to process if the material is thick, the thin plate for forming the bobbin 11 of this voice coil device 10 according to the embodiment can be made thin as described above, and therefore is easy to process.

Another problem with high-strength metal materials such as titanium is that the material has smooth and hard surface, which causes the voice coil wires to readily slip off from the bobbin at high input levels. With the voice coil device 10 according to the embodiment of the invention in which the voice coil wires are wound around on the heat-resistant fiber/resin composite film 12 attached to the surface of the bobbin 11, the wires are well retained on the bobbin because the friction resistance of the film 12 is high due to high surface roughness of the film 12 containing fiber cloth and because the wires sink into the elastic film 12. Even if the adhesive layer on the surface of the wires is softened and thermally decomposed by the heat caused by high input power, the wires do not come off from the bobbin 11. The voice coil device 10 thus has much improved high-input durability.

Furthermore, because the wires sink into the heat-resistant fiber/resin composite film 12 as they are wound around during the production of the voice coil device 10, the wires are easily set in predetermined positions and the work efficiency of the wire winding process is improved.

If the bobbin is made of a thin metal material alone, the oscillating movement of the bobbin at high input levels can result in distortion of the bobbin, or the bending motion of the bobbin at high input levels can create a crack at the interface between the bobbin and the voice coil wires. However, with the voice coil device 10 according to the embodiment of the invention, the heat-resistant fiber/resin composite film 12 is attached along the height direction of the bobbin 11 from the bottom end of the voice coil 13 over the area including the interface between the voice coil wires and the bobbin 11. The film 12 thus provides strength against the oscillating movement and protects the interface from cracks, and prevents damage of the bobbin 11 at high input levels.

Moreover, heat generated in the voice coil 13 is partly insulated by the heat-resistant fiber/resin composite film 12 and hardly conducted to the metal bobbin 11, and therefore, the joints between the voice coil device 10 and the diaphragm or the like do not suffer thermal damage even at high input levels.

As described above, the voice coil device 10 according to the embodiment of the invention has the following characteristics: The voice coil device has sufficient strength to achieve high-input durability. The bobbin can be formed with high roundness using a high-strength metal material such as titanium, whereby damage to the voice coil wires is prevented. The weight of the bobbin can be reduced to achieve a high sound pressure level while maintaining sufficient durability. Furthermore, the voice coil device is free of the problem of wire slippage from the bobbin and the problem of voice coil device detachment.

### WORKING EXAMPLE

### Examples of Materials for the Voice Coil Device and Comparison of Strength

The following table shows a comparison of strength between a working example of the invention (bobbin: titanium; heat-resistant fiber/resin composite film: glass cloth containing phenolic resin) and five comparative examples of bobbins made of various metal materials.

TABLE 1

| | | | | Tensile | |
|---|---|---|---|---|---|
| | | Bobbin | Film | strength | No. of |
| | | Thickness | Thickness | (N/5 mm | Bending |
| | Material | (mm) | (mm) | width) | Times |
| Comparative | Aluminum | 0.10 | — | 92.2 | 3 |
| Example 1 | | | | | |
| Comparative | Aluminum | 0.15 | — | 140.8 | 2 |
| Example 2 | | | | | |
| Comparative | Titanium | 0.10 | — | 173.8 | 20 |
| Example 3 | | | | | |
| Comparative | Titanium | 0.15 | — | 223.7 | 14 |
| Example 4 | | | | | |
| Comparative | *1 | — | 0.075 | 61.9 | 1 |
| Example 5 | | | | | |
| Working | *2 | 0.10 | 0.075 | 251.3 | 36 |
| Example | | | | | |

*1: Glass cloth containing phenolic resin alone
*2: Titanium bobbin and glass cloth containing phenolic resin

As can be seen from the table above, the working example of the invention exhibited sufficiently high tensile strength as compared to bobbins made of a metal material alone and with the same or larger thickness. Also, the working example showed sufficient strength against bending that accompanies the vibration. For the bending test, the bobbin materials were cut into 25 mm wide strips, and bent at 90° to one side and to the other thirty times per a minute using a weight of 1 kg, and the number of bending until the materials broke was counted.

### Speaker Example

FIG. 5 illustrates one example of a speaker to which the above-described embodiment of the voice coil device 10 is applied. While the illustrated example has a cone-shaped diaphragm, it goes without saying that the invention can be applied to various other types such as dome-shaped diaphragms, flat-type diaphragms and the like.

The illustrated speaker SP includes a magnet 1, a yolk 2 attached to the bottom face of the magnet 1, a center plate 3 attached to the top face of the magnet 1, a diaphragm 4, a center cap 5, and the above-described voice coil device 10.

The magnet 1 is, for example, a neodymium magnet or the like having high magnetic flux density and has a disc-like shape. The yolk 2 consists of a bottom plate 2A, a side wall 2B, and an annular plate 2C, which are all made of a magnetic material such as iron or iron alloys. A magnetic gap is formed between an inner circumferential surface of the annular plate 2C and an outer circumferential surface of the center plate 3 so that a magnetic circuit is formed by the magnetic gap, the magnet 1, and the yolk 2. The center plate 3 is also made of a magnetic material such as iron or iron alloys, has a disc-like shape, and is attached to the magnet 1.

The voice coil device 10 is supported such that the voice coil 13 is positioned inside this magnetic gap, and when a signal is input to the voice coil 13, its vibration is transmitted to the diaphragm 4.

The diaphragm 4 is formed by any of paper making using paper pulp, injection molding using polypropylene or other resin, or press machining using thin plate alloy of aluminum, titanium, beryllium or the like. An edge member 4A secures the diaphragm 4 to the outer peripheral edge of a frame 6 that is mounted on the yolk 2. A gasket 7 is attached to the outer peripheral edge of the frame 6 near the edge member 4A so as to maintain the air-tightness of the inside of the frame 6.

The speaker SP thus structured and employing the voice coil device 10 with the above-described characteristic features has high-input durability and a high sound pressure level.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A voice coil device for transmitting vibration of a voice coil generated by an input signal to a speaker diaphragm, comprising:
a bobbin made by rounding a thin plate of a high-strength metal material into a tubular shape;
a heat-resistant fiber/resin composite film attached to a surface of the bobbin such as to cover at least abutting ends of the thin plate; and
a wire for the voice coil wound around on the heat-resistant fiber/resin composite film.

2. The voice coil device according to claim 1, wherein
the high-strength metal material comprises titanium as a main component.

3. The voice coil device according to claim 1, wherein
the heat-resistant fiber/resin composite film is attached to an entire circumference of the bobbin.

4. The voice coil device according to claim 1, wherein
the heat-resistant fiber/resin composite film is attached such as to extend over an entire height of the bobbin.

5. A method of manufacturing a voice coil device for transmitting vibration of a voice coil generated by an input signal to a speaker diaphragm, the method comprising the steps of:
forming a bobbin by rounding a thin plate of a high-strength metal material into a tubular shape;
attaching a heat-resistant fiber/resin composite film to a surface of the bobbin such as to cover at least abutting ends of the thin plate; and
winding a wire for the voice coil around on the heat-resistant fiber/resin composite film.
